(19) United States
(12) Patent Application Publication
(10) Pub. No.: US 2010/0202731 A1
(43) Pub. Date: Aug. 12, 2010

(54) OPTICAL WAVEGUIDE AND METHOD FOR MANUFACTURING THE SAME

(75) Inventor: Kenichi Mitsumori, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/766,708

(22) Filed: Apr. 23, 2010

Related U.S. Application Data
(63) Continuation of application No. PCT/JP2008/071028, filed on Nov. 19, 2008.

(30) Foreign Application Priority Data
Nov. 19, 2007 (JP) 2007-299296
Feb. 14, 2008 (JP) 2008-033414
Oct. 31, 2008 (JP) 2008-281563

(51) Int. Cl. G02B 6/26; G02B 6/00; G02B 6/10

(52) U.S. Cl. 385/31; 385/142; 264/1.28

(57) ABSTRACT

An optical waveguide includes a cladding film and a core formed integrally with the cladding film. The core includes a light guide portion formed on one surface of the cladding film, a light input portion, and a light output portion, the light input portion and the light output portion being formed in through-holes formed in the cladding film. A mirror surface is respectively formed at a connecting portion between the light guide portion and the light input portion and a connecting portion between the light guide portion and the light output portion. In manufacturing the optical waveguide, the cladding film is brought into close contact with a surface of a mold, the surface having a recessed groove thereon, and a UV-curable resin is injected under pressure through one of the through-holes opened in the cladding film into the recessed groove.

### CLAIM OF PRIORITY

This application is a Continuation of International Application No. PCT/JP2008/071028 filed on Nov. 19, 2008, which claims benefit of the Japanese Patent Application Nos. 2008-281563 filed on Oct. 31, 2008, 2007-299296 filed on Nov. 19, 2007, and 2008-033414 filed on Feb. 14, 2008, all of which are hereby incorporated by reference.

### BACKGROUND OF THE INVENTION

1. Field of the Invention

The present invention relates to a structure of an optical waveguide in which a core composed of a polymeric material is integrally formed with a flexible cladding film and a method for manufacturing the same.

2. Description of the Related Art

Heretofore, an optical waveguide shown in FIG. 13 is known as an example of the above type of optical waveguide. Specifically, an optical waveguide 100 includes a cladding film 101 and a core 102 provided on one surface of the cladding film 101, and a light input surface 102a and a light output surface 102b of the core 102 are arranged to be flush with the end surfaces of the cladding film 101 (refer to, for example, Japanese Unexamined Patent Application Publication No. 2005-202230).

This optical waveguide 100 is manufactured through the steps of (A) to (F) shown in FIGS. 14A to 14E Specifically, the optical waveguide is manufactured by (A) preparing, by a photolithographic method or the like, a master 200 on which a protrusion 201 corresponding to a core to be manufactured is formed, (B) transferring the protrusion 201 formed on the master 200 to a curable resin for forming a mold to prepare a cured resin layer 203 in which a recess 202 corresponding to the protrusion 201 is formed; (C) forming through-holes 204 and 205 at ends of the recess 202 formed in the cured resin layer 203 to prepare a resin mold 206; (D) bringing a cladding film 101 into close contact with a surface of the mold 206, the surface having the recess 202 thereon, and then performing suction through the through-hole 204 under reduced pressure while supplying a curable resin 207 for forming the core through the through-hole 205 to fill the recess 202 with the curable resin 207 for forming the core; (E) detaching the cladding film 101 from the mold 206 to obtain an intermediate product 209 in which a core 102 and resin portions 208 cured in the through-holes 204 and 205 are formed on one surface of the cladding film 101; and (F) cutting the resin portions 208 of the intermediate product 209 with a dicer or the like to obtain the optical waveguide 100 in which the core 102 is provided on the one surface of the cladding film 101 (refer to, for example, Japanese Unexamined Patent Application Publication No. 2005-202230).

Another known example of this type of optical waveguide has a structure in which a core composed of a polymeric material is integrally formed between two flexible cladding films. The following method has been proposed as a method for manufacturing this optical waveguide. Specifically, a clad base member having a groove for forming a desired core (optical waveguide pattern) therein and a clad-covering member that covers the core are molded using molds. A cavity formed by stacking the clad base member and the clad-covering member is filled with a high-refractive-index resin using a capillary phenomenon. Subsequently, the filling high-refractive-index resin is cured to manufacture the optical waveguide in which the core is completely protected by being covered with the clad base member and the clad-covering member (refer to, for example, Japanese Unexamined Patent Application Publication No. 4-77705).

According to this method, since the groove for forming the core is formed in the clad base member in advance, it is possible to manufacture an optical waveguide in which the core is completely protected by being covered with the clad base member and the clad-covering member at relatively high efficiency.

In the optical waveguide 100 in the related art shown in FIG. 13, the light input surface 102a and the light output surface 102b of the core 102 are arranged at the end surface sides of the cladding film 101. Therefore, alignment of a light-emitting side device with respect to the light input surface 102a and alignment of a light-receiving side device with respect to the light output surface 102b are difficult to achieve, resulting in problems such as an increase in the size and an increase in the cost of an optical device provided with the optical waveguide 100. More specifically, since the cladding film 101 is composed of a flexible resin film having a thickness in the range of about 50 to 100 μm, it is practically impossible to directly set the light-emitting side device and the light-receiving side device on the end surfaces of the film. Accordingly, a jig is necessary, and thus the number of components increases, thereby increasing the size and the cost of the optical device provided with the optical waveguide 100. Furthermore, it is necessary to provide a jig between the optical waveguide 100 and the light-emitting side device and light-receiving side device, and therefore, in order to accurately align the light-emitting side device and the light-receiving side device with respect to the light input surface 102a and the light output surface 102b, respectively, of the core 10, the light-emitting side device and the light-receiving side device must be respectively moved in three-dimensional directions with respect to the light input surface 102a and the light output surface 102b of the core 102. Consequently, a large amount of labor is required for assembling respective components. Also from this standpoint, the cost of the optical device provided with the optical waveguide 100 increases.

In addition, according to the method for manufacturing the optical waveguide in the related art shown in FIGS. 14A to 14F, after the preparation of the intermediate product 209 in which the core 102 and the resin portions 208 cured in the through-holes 204 and 205 are formed on one surface of the cladding film 101, it is necessary to cut the resin portions 208 with a dicer or the like, resulting in problems that the production process becomes complex, and it is difficult to efficiently manufacture non-defective products. Specifically, if a mold material for forming the core and an exposure method are devised so that only the curable resin 207 supplied to the portion to be formed into the core 102 is selectively cured, non-defective products can be more efficiently manufactured. There is room for improvement in this point.

On the other hand, according to the method described in Japanese Unexamined Patent Application Publication No. 4-77705, the clad base member is bonded to the clad-covering member, and the cavity is then filled with the high-refractive-index resin from an end surface of the resulting laminate using a capillary phenomenon. Accordingly, the production process is so-called a batch process, resulting in a problem of a difficulty of further increasing the production efficiency of the optical waveguide.

### SUMMARY OF THE INVENTION

The present invention has been made in order to solve the above technical problems. The present invention provides an optical waveguide in which a light-emitting side device and a light-receiving side device can be easily set with respect to a light input surface and a light output surface, respectively, of a core, thereby reducing the size and the cost of an optical device. The present invention also provides a method for manufacturing an optical waveguide in which this type of optical waveguide can be efficiently manufactured.

To solve the above problems, a method for manufacturing an optical waveguide according to an embodiment of the present invention includes the steps of bringing a grooved member having, on one surface thereof, a recessed groove for forming a light guide portion into close contact with a cladding film having a first through-hole and a second through-hole at positions corresponding to both ends of the recessed groove; and then filling, under pressure, the second through-hole, the recessed groove, and the first through-hole with a polymeric material for forming a core through the second through-hole while suctioning the air in the first through-hole, the recessed groove, and the second through-hole through the first through-hole.

According to this configuration, since the grooved member having the recessed groove is brought into close contact with the cladding film having the first through-hole and the second through-hole, a cavity for being filled with a polymeric material corresponding to the recessed groove and the first and second through-holes is formed between the grooved member and the cladding film. Accordingly, a light guide portion provided with a light input portion and a light output portion at both ends thereof can be formed by filling the cavity with a polymeric material under pressure. Furthermore, in the filling with the resin under pressure, the second through-hole, the recessed groove, and the first through-hole are filled under pressure with the polymeric material for forming a core through the second through-hole while suctioning the air in the first through-hole, the recessed groove, and the second through-hole through the first through-hole. Accordingly, the filling of the polymeric material can be performed with high efficiency, mixing of air bubbles in the polymeric material can be prevented, and non-defective products can be manufactured with high efficiency.

The grooved member may be a mold separate from the optical waveguide.

The mold is detached from the optical waveguide after the formation of the core. Accordingly, when such a mold separate from the optical waveguide is used as the grooved member, an optical waveguide in which a cladding film is provided on only one surface of the core can be manufactured.

The grooved member may be another cladding film constituting a cladding of the optical waveguide together with the cladding film.

According to this configuration, an optical waveguide in which both the top surface and the bottom surfaces of the core are covered with the cladding films can be easily manufactured.

The method may further include a step of forming the recessed groove on the one surface of the grooved member so that mirror surfaces constituted by inclined surfaces are integrally formed at both ends of the recessed groove.

When mirror surfaces are formed at both ends of the recessed groove, light incident on the light input portion can be reflected at one of the mirror surfaces and guided to the light guide portion, and the light that has propagated through the light guide portion can be reflected at the other mirror surface and guided to the light output portion. Accordingly, light incident on the light input portion can be efficiently guided to the light output portion, thus obtaining an optical waveguide having high light propagation efficiency.

In this case, the method may further include a step of forming a reflective film on at least the mirror surfaces out of the bottom surface of the recessed groove and the mirror surfaces, the step being performed after the formation of the recessed groove and the mirror surfaces on the grooved member.

The formation of the reflective film on the mirror surfaces can increase the light reflection efficiency in the mirror surfaces. Accordingly, even when a sufficient difference in the refractive index between the core and the cladding film cannot be ensured, an optical waveguide having high light propagation efficiency can be provided.

In the above method, in the case where the grooved member is a mold, after the polymeric material for forming the core, the polymeric material filling the first through-hole, the recessed groove, and the second through-hole under pressure is cured, the reflective film may be transferred to at least the mirror surfaces out of the bottom surface of the core and the mirror surfaces when the grooved member functioning as the mold is detached from the core.

The reflective film is composed of a metal, such as aluminum, silver, or gold, having a high reflectivity at the wavelength used in the optical waveguide. The reflective film may be formed directly on the mirror surfaces by vacuum evaporation or the like. Alternatively, the reflective film may be formed by transferring a reflective film formed on the mirror surfaces of a mold to the mirror surfaces of the core. According to the latter method, the formation of the core and the formation of the reflective film on the mirror surfaces can be competed at the same time, and thus the optical waveguide can be more efficiently manufactured. Note that it is sufficient that the reflective film is formed only on the mirror surfaces. However, in order to reduce the production cost of the optical waveguide, forming the reflective film on the bottom surface of the core is also allowable. That is, in order to form the reflective film only on the mirror surfaces, it is necessary to prepare a mask for limiting the portions where the reflective film is formed to the mirror surfaces only, or it is necessary to perform a post-treatment for removing the reflective film deposited on an unnecessary portion. Accordingly, when forming the reflective film on the bottom surface of the core is allowable, these requirements can be omitted to reduce the production cost of the optical waveguide.

A plurality of the recessed grooves may be formed on the one surface of the grooved member, the first through-hole and the second through-hole may be formed in the cladding film, a connecting recessed groove connecting an end of one recessed groove to an end of another recessed groove, the recessed grooves being formed on the surface of the grooved member, may be formed on one surface of the cladding film, the positions of the ends of the recessed grooves may be adjusted to coincide with the positions of ends of the connecting recessed groove, the position of the first through-hole and the position of the second through-hole may be respectively adjusted to coincide with another end of the one recessed groove and another end of the other recessed groove, and the second through-hole, the other recessed groove, the connecting recessed groove, the one recessed groove, and the first through-hole may then be filled under pressure with the polymeric material for forming the core through the second through-hole while suctioning the air in the first through-hole, the one recessed groove, the connecting recessed groove, the other recessed groove, and the second through-hole through the first through-hole.

The recessed groove has a fine structure with a width and a depth of about several tens of micrometers and is often formed to have a length of about several tens of millimeters in order to maintain the accuracy. It is considerably difficult to form a core having a longer length than this. To overcome this problem, a plurality of the recessed grooves are formed on one surface of the grooved member, a connecting recessed groove is formed on one surface of the cladding film, and the recessed grooves and the connecting recessed groove are connected to each other. In this case, a core having any length can be formed to expand the application range of this type of optical waveguide.

The method according to an embodiment of the present invention may further include the steps of preparing a mold having a recessed groove for forming a light guide portion, a cladding film, and a pressing jig having a resin injection port and an evacuation port at positions corresponding to both ends of the recessed groove; bringing the cladding film into close contact with the surface of the mold, the surface having the recessed groove thereon; forming the first through-hole and the second through-hole for respectively forming a light input portion and a light output portion in the cladding film at positions corresponding to both ends of the recessed groove; placing the pressing jig on the cladding film so that the positions of the first and second through-holes formed in the cladding film respectively coincide with the positions of the resin injection port and the evacuation port formed in the pressing jig; fixing the mold and the cladding film using the pressing jig, and then filling, under pressure, the resin injection port, the first through-hole, the recessed groove, the second through-hole, and the evacuation port with a polymeric material for forming a core through the resin injection port while suctioning the air in the evacuation port, the second through-hole, the recessed groove, the first through-hole, and the resin injection port through the evacuation port; selectively curing only the polymeric material filling the recessed groove and the polymeric material filling the first and second through-holes to form the core so that the polymeric material filling the resin injection port and the polymeric material filling the evacuation port are left uncured; and detaching the pressing jig from the surface of the cladding film, and detaching the cladding film having the core integrally formed therewith from the mold.

In this configuration, after the cladding film is brought into close contact with a surface of the mold, the surface having a recessed groove thereon, the first and second through-holes for respectively forming a light input portion and a light output portion are formed in the cladding film at positions corresponding to both ends of the recessed groove. Accordingly, the first and second through-holes can be formed with high accuracy with respect to both ends of the recessed groove, and thus the core having a desired shape can be formed with high accuracy. Furthermore, unlike the case where a cladding film in which the first and second through-holes are formed in advance is brought into close contact with a mold, alignment between both ends of the recessed groove and the first and second through-holes is not necessary, and thus a desired optical waveguide can be manufactured with high efficiency. In addition, when a pressing jig is placed on the cladding film, and an appropriate pressure is applied to the mold and the cladding film, misalignment between the mold and the cladding film can be reliably prevented in the subsequent steps, thus manufacturing non-defective products with high efficiency. Furthermore, in this configuration, the resin injection port, the first through-hole, the recessed groove, the second through-hole, and the evacuation port is filled under pressure with a polymeric material for forming a core through the resin injection port while suctioning the air in the above-mentioned portions through the evacuation port. Accordingly, the filling of the polymeric material can be performed with high efficiency, mixing of air bubbles in the polymeric material can be prevented, and non-defective products can be manufactured with high efficiency. Furthermore, since only the polymeric material filling the recessed groove and the polymeric material filling the first and second through-holes are selectively cured instead of curing all the filling polymeric material, it is not necessary to perform a post-treatment of unnecessary cured polymeric material portions. Thus, the optical waveguide can be manufactured with high efficiency.

In the above method, the pressing jig may be composed of a transparent material, and a light-shielding film may be selectively provided on necessary portions including at least a wall surface of the resin injection port and a wall surface of the evacuation port, the polymeric material for forming the core may be a UV-curable resin, and after the resin injection port, the first through-hole, the recessed groove, the second through-hole, and the evacuation port are filled with the UV-curable resin for forming the core through the resin injection port, resin-curing light may be applied to the entire surface of the pressing jig.

According to this configuration, the light-shielding film can prevent the UV-curable resin filling the resin injection port and the evacuation port formed in the pressing jig from being cured, and thus a post-treatment for removing the cured UV-curable resin is not necessary, and a large number of optical waveguides can be continuously manufactured using a single pressing jig. In addition, since the entire surface of the pressing jig is irradiated with the resin-curing light, a necessary portion of the UV-curable resin can be cured easily and with high efficiency.

In the above method, the pressing jig may be composed of an opaque material and may have a hole for exposure, the hole being disposed at a position different from the positions of the resin injection port and the evacuation port, the polymeric material for forming the core may be a UV-curable resin, and after the resin injection port, the first through-hole, the recessed groove, the second through-hole, and the evacuation port are filled with the UV-curable resin for forming the core through the resin injection port, the pressing jig may be moved so that the position of the hole for exposure coincides with the position of the first through-hole or the second through-hole formed in the cladding film, and resin-curing light may be applied to the UV-curable resin filling the first and second through-holes and the UV-curable resin filling the recessed groove through the hole for exposure.

According to this configuration, after the filling of the UV-curable resin, the pressing jig is moved so that the position of the hole for exposure formed in the pressing jig coincides with the position of the first through-hole or the second through-hole formed in the cladding film, and resin-curing light is applied through the hole for exposure to the UV-curable resin filling the first and second through-holes and the UV-curable resin filling the recessed groove. Accordingly, the resin-curing light incident on one of the through-holes propagates through the UV-curable resin filling the through-hole, the UV-curable resin filling the recessed groove, and the UV-curable resin filling the other through-hole. Thus, the UV-curable resin filling each of the through-holes and the UV-curable resin filling the recessed groove can be reliably cured. Furthermore, during the exposure of the UV-curable resin, the resin injection port and the evacuation port provided in the pressing jig have been moved from the exposure portion, thus reliably preventing the UV-curable resin remaining in each of these ports from being cured.

In the above method, the pressing jig may be composed of an opaque material, may be provided with switching means for switching between a resin injection path and an exposure path, the switching means being disposed at a position communicating with the resin injection port and the first through-hole and a position communicating with the evacuation port and the second through-hole, and may have a hole for exposure communicating with one of the switching means, the polymeric material for forming the core may be a UV-curable resin, the switching means may be switched to a state in which the resin injection port communicates with the first through-hole and the evacuation port communicates with the second through-hole, and the resin injection port, the first through-hole, the recessed groove, the second through-hole, and the evacuation port may be filled with the UV-curable resin for forming the core through the resin injection port, and the switching means may then be switched to a state in which the hole for exposure communicates with the first through-hole or the second through-hole, and resin-curing light may be applied to the UV-curable resin filling the first and second through-holes and the UV-curable resin filling the recessed groove through the hole for exposure.

According to this configuration, both supply of the UV-curable resin to the first and second through-holes and the recessed groove and curing of the UV-curable resin filling these portions can be performed by adequately switching the switching means. Accordingly, this process can be conducted while applying a pressure to the cladding film and the mold using the pressing jig, thus preventing misalignment between the cladding film and the mold. Furthermore, not only alignment between the hole for exposure formed in the pressing jig and a through-hole formed in the cladding film is not necessary but also curing of unnecessary portions of the resin due to exposure of the portions can be prevented. Consequently, the optical waveguide can be more efficiently manufactured.

In this case, the switching means for switching between the resin injection path and the exposure path may each include a slider insertion space formed in the pressing jig and a slider configured to be inserted into the slider insertion space.

According to this configuration, both supply of the UV-curable resin to the first and second through-holes and the recessed groove and exposure of the UV-curable resin filling the first and second through-holes and the recessed groove can be performed by simply sliding the sliders in the slider insertion spaces provided in the pressing jig. Accordingly, the movement of the pressing jig can be simplified, and thus the optical waveguide can be manufactured more efficiently.

The method according to an embodiment of the present invention may further include the steps of preparing a first cladding film having a recessed groove for forming a light guide portion having inclined mirror surfaces at both ends thereof and a second cladding film having a first through-hole and a second through-hole for respectively forming a light input portion and a light output portion at positions corresponding to both ends of the recessed groove; bonding the second cladding film to a surface of the first cladding film, the surface having the recessed groove thereon, so that the first through-hole and the second through-hole face the ends of the recessed groove; filling the recessed groove and one of the first through-hole and the second through-hole with a polymeric material for forming a core through the other through-hole; and curing the filling polymeric material to form the core including the light input portion, the light guide portion, the light output portion, a first mirror surface configured to guide light incident on the light input portion to the light guide portion, and a second mirror surface configured to guide the light that has propagated through the light input portion to the light output portion, the core being formed integrally with the first and second cladding films.

According to this configuration, the recessed groove and the first through-hole or the second through-hole formed in the second cladding film are filled with the polymeric material for forming the core through the other through-hole. Accordingly, it is not necessary to complete forming of the first cladding film and the second cladding film before the filling of the polymeric material, and thus the optical waveguide can be manufactured by a continuous process. Thus, it is possible to highly efficiently manufacture an optical waveguide in which the core is completely protected by being covered with the first cladding film and the second cladding film.

In the above method, the step of preparing the first cladding film and the second cladding film may include preparing a ribbon-shaped first cladding film including a large number of the recessed grooves formed in the longitudinal direction at certain intervals and winding the first cladding film around a first reel, and preparing a ribbon-shaped second cladding film including a large number of the first and second through-holes formed in the longitudinal direction at certain intervals and winding the second cladding film around a second reel, and the step of bonding the second cladding film to the surface of the first cladding film, the surface having the recessed groove thereon, may include bonding the first cladding film drawn from the first reel to the second cladding film drawn from the second reel.

According to this configuration, all the production of the first and second cladding films, the bonding of the first cladding film to the second cladding film, the filling of the polymeric material in the bonded first and second cladding films, and the curing of the filling polymeric material can be continuously performed, thus further increasing the production efficiency of the optical waveguide.

In the method, the step of preparing the first cladding film may include preparing a mold having a protrusion corresponding to the recessed groove and a film base to be formed into the first cladding film, and pressing the film base onto a surface of the mold, the surface having the protrusion thereon, under heating to transfer the recessed groove corresponding to the protrusion to one surface of the film base.

A technique for heat-transferring a fine irregular pattern formed on a mold to a resin film has been established as so-called a “thermal imprinting process”. According to this technique, such a fine irregular pattern can be transferred to a film base with high efficiency and high accuracy, and thus a high-performance optical waveguide can be manufactured at a low cost.

In the method, the step of filling the first through-hole, the recessed groove, and the second through-hole with the polymeric material for forming the core may include holding the lower surface of the first cladding film with a film holder, pressing the top surface of the second cladding film with a pressing jig having a resin injection port corresponding to the first through-hole and an evacuation port corresponding to the second through-hole, and filling, under pressure, the second through-hole, the recessed groove, and the first through-hole with the polymeric material for forming the core through the resin injection port while suctioning the air in the first through-hole, the recessed groove, and the second through-hole through the evacuation port.

According to this configuration, since the lower surface of the first cladding film and the top surface of the second cladding film are respectively held with the film holder and the pressing jig. Therefore, the filling of the polymeric material in the first through-hole, the recessed groove, and the second through-hole can be stably performed.

In this case, the step of curing the filling polymeric material may include selectively curing only the polymeric material filling the second through-hole, the recessed groove, and the first through-hole to leave the polymeric material filling the resin injection port and the evacuation port uncured.

According to this configuration, the polymeric material filling the resin injection port and the evacuation port is left uncured. Therefore, the filling of the polymeric material can be continuously repeated using the same pressing jig without performing a post-treatment of cured portions to manufacture the optical waveguide with high efficiency.

To solve the above problems, an optical waveguide according to an embodiment of the present invention includes a cladding film; and a core composed of a polymeric material and formed integrally with the cladding film, wherein the core includes a light guide portion formed on one surface of the cladding film, a light input portion, and a light output portion, the light input portion and the light output portion being connected to both ends of the light guide portion and being formed in through-holes provided in the cladding film in the same step as the formation of the light guide portion.

According to this configuration, a light input surface and a light output surface of the optical waveguide can be arranged so as to be flush with the surface of the cladding film. Therefore, a light-emitting side device and a light-receiving side device can be directly attached to the surface of the cladding film, and no jig is necessary. Consequently, the size and the cost of an optical device provided with the optical waveguide can be reduced by decreasing the number of components. Furthermore, since the light-emitting side device and the light-receiving side device can be directly attached to the surface of the cladding film, it is sufficient that alignment of the light-emitting side device and the light-receiving side device with respect to the light input surface and the light output surface, respectively, of the optical waveguide is performed only with respect to a two-dimensional direction along the surface of the cladding film, thus simplifying the assembly of the optical device provided with the optical waveguide. Furthermore, according to this configuration, the light input surface and the light output surface of the optical waveguide penetrate the through-holes formed in the cladding film and are exposed on the surface side of the cladding film. Accordingly, light emitted from the light-emitting side device can be directly guided to the core and the light that has propagated through the core can be directly guided to the light-receiving side device. Thus, an optical waveguide having high light propagation efficiency can be provided.

The optical waveguide may further include a mirror surface configured to guide light incident on the light input portion to the light guide portion; and a mirror surface configured to guide the light that has propagated through the light guide portion to the light output portion, the mirror surfaces being disposed at both ends of the light guide portion.

According to this configuration, since light can be totally reflected by the mirror surfaces, light incident on the light input portion can be efficiently guided to the light output portion. Thus, an optical waveguide having high light propagation efficiency can be provided.

The light guide portion, the light input portion, and the light output portion may have substantially the same cross-sectional shape and cross-sectional area.

According to this configuration, loss of light inside the core due to variations in the cross-sectional area of respective portions can be prevented or suppressed, and thus an optical waveguide having high light propagation efficiency can be provided. Note that the term “substantially the same” means “within a range of unavoidable error” in the formation of the light guide portion, the light input portion, and the light output portion.

The core may be composed of a UV-curable resin.

The core can be composed of any polymeric material having a good light-transmitting property. In particular, when the core is composed of a UV-curable resin, a desired core can be formed by simply applying resin-curing light having a predetermined wavelength, and thus the optical waveguide can be easily manufactured. In addition, since UV-curable resins do not chemically or physically affect the first and second cladding films, non-defective products can be manufactured at a high yield. Furthermore, only a desired portion can be selectively cured by controlling the irradiation range of the resin-curing light. Accordingly, post-treatments, such as cutting and washing, required when unnecessary portions are cured need not be performed to simplify the manufacturing of the optical waveguide.

The light guide portion of the core may be covered with two cladding films.

According to this configuration, since the light guide portion of the core is covered with two cladding films, leakage of light from the core can be reliably suppressed, as compared with the case where only one cladding film is used. Thus, an optical waveguide having higher light propagation efficiency can be provided.

In the optical waveguide according to an embodiment of the present invention, a reflective film may be provided on each of the mirror surfaces.

According to this configuration, since the reflective film is provided on each of the mirror surfaces, the light reflection efficiency in the mirror surfaces can be increased. Accordingly, even when a sufficient difference in the refractive index between the core and the cladding film cannot be ensured, an optical waveguide having high light propagation efficiency can be provided.

In the optical waveguide according to an embodiment of the present invention, the light guide portion may include a plurality of first light guide portions provided on one of the two cladding films and a second light guide portion provided on the other cladding film and optically connected to ends of the first light guide portions either directly or through connecting light guide portions.

According to this configuration, since the light guide portion is constituted by a plurality of first light guide portions provided in one of the cladding films and a second light guide portion provided in the other cladding film, a light guide portion having any length can be formed to expand the application range of this type of optical waveguide.

### BRIEF DESCRIPTION OF THE DRAWINGS

FIG. 1 is a cross-sectional view of an optical waveguide according to a first embodiment;

FIG. 2 is a cross-sectional view of an optical waveguide according to a second embodiment;

FIGS. 3A to 3D are views illustrating a first embodiment of a method for manufacturing an optical waveguide;

FIGS. 4A and 4B are views illustrating a second embodiment of a method for manufacturing an optical waveguide;

FIGS. 5A and 5B are views illustrating a third embodiment of a method for manufacturing an optical waveguide;

FIGS. 6A and 6B are views illustrating a fourth embodiment of a method for manufacturing an optical waveguide;

FIGS. 7A to 7F are views illustrating a fifth embodiment of a method for manufacturing an optical waveguide;

FIG. 8 is a view illustrating a more practical embodiment of a method for manufacturing an optical waveguide according to the present invention;

FIG. 9 is a cross-sectional view of an optical waveguide according to a third embodiment;

FIG. 10 is a cross-sectional view of an optical waveguide according to a fourth embodiment;

FIG. 11 is a cross-sectional view of an optical waveguide according to a fifth embodiment;

FIG. 12 is a cross-sectional view of an optical waveguide according to a sixth embodiment;

FIG. 13 is a perspective view of an optical waveguide in the related art; and

FIGS. 14A to 14F are views illustrating steps of a method for manufacturing an optical waveguide in the related art.

### DESCRIPTION OF THE PREFERRED EMBODIMENTS

### First Embodiment and Second Embodiment of Optical Waveguide

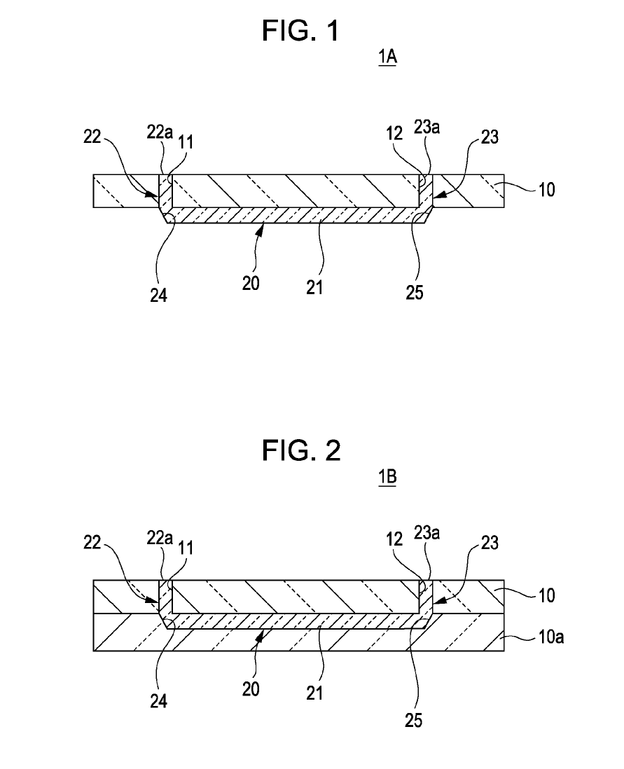

Optical waveguides according to a first embodiment and a second embodiment of the present invention will now be described with reference to FIGS. 1 and 2. FIG. 1 is a cross-sectional view of the optical waveguide according to the first embodiment, and FIG. 2 is a cross-sectional view of the optical waveguide according to the second embodiment.

As shown in FIG. 1, an optical waveguide 1A of the first embodiment includes a cladding film 10 and a core 20 that is composed of a polymeric material and that is formed to be integrated with the cladding film 10. The core 20 is composed of a light guide portion 21 formed on one surface of the cladding film 10, a light input portion 22 and a light output portion 23 that are respectively formed in through-holes 11 and 12 provided in the cladding film 10 and that are connected to both ends of the light guide portion 21, a mirror surface 24 formed at a connecting portion between the light guide portion 21 and the light input portion 22, and a mirror surface 25 formed at a connecting portion between the light guide portion 21 and the light output portion 23. An end surface 22a of the light input portion 22 is arranged to be flush with the surface of the cladding film 10, and this surface 22a functions as a light input surface. Similarly, an end surface 23a of the light output portion 23 is also arranged to be flush with the surface of the cladding film 10, and this surface 23a functions as a light output surface. Note that whether one end or the other end of the core 20 is used as the light input portion 22 or the light output portion 23 can be adequately determined according to need.

The mirror surface 24 totally reflects light incident on the light input portion 22 to guide the light to the light guide portion 21. The mirror surface 24 is configured to have an inclined surface inclined by 45° with respect to the light guide portion 21 and the light input portion 22. On the other hand, the mirror surface 25 totally reflects the light that has propagated through the light guide portion 21 to guide the light to the light output portion 23. The mirror surface 25 is configured to have an inclined surface inclined by 45° with respect to the light guide portion 21 and light output portion 23. When the mirror surfaces 24 and 25 are formed at the necessary positions of the core 20 in this manner, light incident on the light input portion 22 can be efficiently guided to the light output portion 23 to increase the light propagation efficiency in the optical waveguide 1A.

As shown in FIG. 2, in an optical waveguide 1B of the second embodiment, a light guide portion 21 of a core 20 is covered with a second cladding film 10a. According to this optical waveguide 1B of this embodiment, since the light guide portion 21 of the core 20 is covered with the second cladding film 10a, leakage of light from the core 20 can be reliably suppressed to increase the light propagation efficiency and to increase physical and chemical resistance, as compared with the case where only a cladding film 10 is provided. Other structures are the same as those of the optical waveguide 1A according to the first embodiment, and thus corresponding portions are assigned the same reference numerals and a description thereof is omitted. Note that the second cladding film 10a is particularly preferably bonded to the cladding film 10 in order to prevent the second cladding film 10a from detaching.

The materials for the cladding film 10 and the second cladding film 10a are selected in consideration of optical properties, such as the refractive index, mechanical strength, heat resistance, adhesiveness to the core 20 and a mold described below, flexibility, water-absorbing property, and the like in accordance with the application of an optical device provided with the optical waveguide 1A or 1B. Specific examples of the usable materials include alicyclic acrylic resin films and alicyclic olefin resin films, all of which have a refractive index of less than 1.55 for the purpose of ensuring a difference in the refractive index from the core 20, and a thickness in the range of about 50 to 100 μm.

The core 20 may be composed of any publicly known polymeric material so long as the polymeric material has a necessary refractive index and optical transparency. In particular, UV-curable resins are preferable because only a desired portion can be selectively cured by controlling a range to be irradiated with resin-curing light, thereby simplifying the production of the core 20, and furthermore, the optical waveguides 1A and 1B. The cross-sectional shape of the core 20 is a rectangle, and the width and the height thereof are determined to be in the range of about 15 to 100 μm in accordance with the application of the optical device provided with the optical waveguide 1A or 1B. The light guide portion 21, the light input portion 22, and the light output portion 23 are formed so that their cross-sectional shapes and the cross-sectional areas are substantially the same in order to prevent or suppress loss of light inside the core 20. Note that a plurality of cores 20 can be formed on a single cladding film 10. For practical purposes, an optical waveguide in which a plurality of cores 20 are formed in a single cladding film 10 is rather generally used.

According to the optical waveguide 1A of the first embodiment and the optical waveguide 1B of the second embodiment, since the light input surface 22a and the light output surface 23a are arranged so as to be flush with the surface of the cladding film 10, a light-emitting side device and a light-receiving side device (not shown) can be directly attached to the surface of the cladding film 10. Accordingly, the size and the cost of an optical device provided with the optical waveguide 1A or 1B can be reduced compared with a case where a jig is arranged between the optical waveguide 1A or 1B and the light-emitting side device and light-receiving side device. In addition, since the light-emitting side device and the light-receiving side device can be directly attached to the surface of the cladding film 10, it is possible to facilitate alignment of the light-emitting side device with respect to the light input surface 22a and alignment of the light-receiving side device with respect to the light output surface 23a of the optical waveguide 1A or 1B, thereby simplifying the assembly of the optical device provided with the optical waveguide 1A or 1B. Furthermore, the light input surface 22a and the light output surface 23a of the optical waveguide 1A or 1B penetrate the through-holes 11 and 12, respectively, and are exposed on the surface side of the cladding film 10. Therefore, light emitted from the light-emitting side device can be directly guided to the core 20 and the light that has propagated through the core 20 can be directly guided to the light-receiving side device. Thus, an optical waveguide having high light propagation efficiency can be provided.

Next, methods for manufacturing optical waveguides according to the first embodiment and the second embodiment will be described.

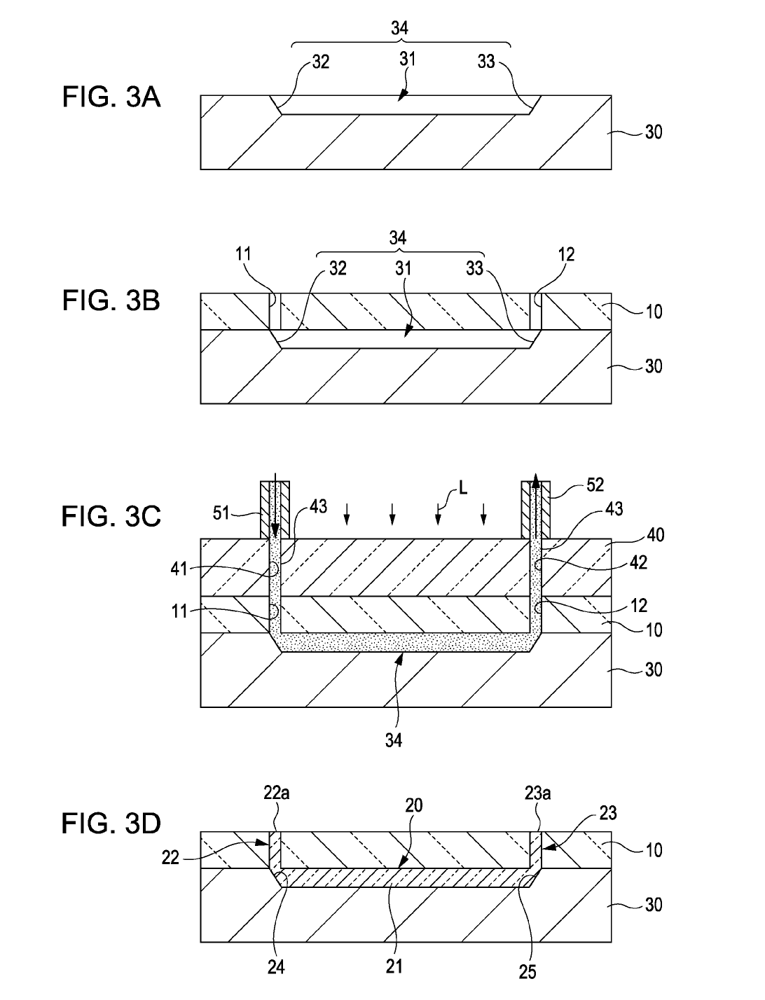

FIGS. 3A to 3D are views illustrating a first embodiment of a method for manufacturing the optical waveguides according to the first embodiment and the second embodiment. As is apparent from the drawings, in the method of this embodiment, a transparent pressing jig may be used, and a UV-curable resin filling a mold may be cured by irradiating the entire surface of the UV-curable resin with resin-curing light from the outside of the pressing jig.

First, as shown in FIG. 3A, a mold 30 having a recessed groove 34 which has a groove portion 31 corresponding to a light guide portion 21 and inclined surfaces 32 and 33 corresponding to the mirror surfaces 24 and 25, respectively, is prepared. The mold is formed of, for example, nickel or a nickel alloy because such a metal exhibits good releasability of resins, and thus a desired light guide portion 21 can be formed with high accuracy. The recessed groove 34 can be formed in the mold 30 as follows. Specifically, the recessed groove 34 may be directly formed by cutting a nickel plate or a nickel alloy plate, which is used as a blank, by laser machining or the like. Alternatively, a master may be prepared by forming a protrusion composed of a photoresist and corresponding to the light guide portion 21 on a glass substrate by a photolithographic technique. Subsequently, the protrusion formed on the master may be transferred to a nickel mold or a nickel alloy mold by a transfer technique using electroforming A mold releasing agent for facilitating the detachment of a core 20 may be applied onto the groove portion 31 and the inclined surfaces 32 and 33.

Next, as shown in FIG. 3B, a cladding film 10 is brought into close contact with a surface of the mold 30, the surface having the recessed groove 34 thereon. Subsequently, a first through-hole 11 and a second through-hole 12 for respectively forming a light input portion 22 and a light output portion 23 are formed by laser machining or the like at positions of the cladding film 10 corresponding to the inclined surfaces 32 and 33, respectively.

Next, as shown in FIG. 3C, a pressing jig 40 composed of a transparent material, e.g., a glass plate or a resin plate, is placed on the cladding film 10. In the pressing jig 40, a resin injection port 41 and an evacuation port 42 are formed at positions corresponding to the first and second through-holes 11 and 12, respectively, formed in the cladding film 10, and a light-shielding film 43 is formed on wall surfaces of the resin injection port 41 and the evacuation port 42. The pressing jig 40 is aligned so that the position of the through-hole 11 coincides with the position of the resin injection port 41, and the position of the through-hole 12 coincides with the position of the evacuation port 42. Subsequently, a head 51 of a resin supply device and a head 52 of a suction device are respectively connected to the resin injection port 41 and the evacuation port 42. The pressure in the recessed groove 34 is reduced by suctioning the air in the through-holes 11 and 12 and the recessed groove 34 using the suction device. When the pressure in the recessed groove 34 is reduced to a predetermined value or less, a UV-curable resin for forming a core is injected from the resin supply device into the through-holes 11 and 12 and the recessed groove 34. Thus, the through-holes 11 and 12 and the recessed groove 34 are filled with the UV-curable resin with high efficiency, mixing of air bubbles in the core 20 can be prevented, and non-defective products can be manufactured with high efficiency. When the through-holes 11 and 12 and the recessed groove 34 are filled with the UV-curable resin, the supply of the resin from the resin supply device is stopped, and light L for curing the UV-curable resin (also referred to as “resin-curing light L”) is applied from the entire surface of the outside of the pressing jig 40. As described above, the wall surfaces of the resin injection port 41 and the evacuation port 42 are covered with the light-shielding film 43. Accordingly, even when the entire surface is irradiated with the resin-curing light L, the UV-curable resin remaining in the resin injection port 41 and the evacuation port 42 is not cured, and only the UV-curable resin injected in the through-holes 11 and 12 and the recessed groove 34 are selectively cured.

Lastly, as shown in FIG. 3D, the pressing jig 40 is removed from the surface of the cladding film 10 and the mold 30 is then detached from the cladding film 10 at the interface therebetween, thus taking out an optical waveguide, which is the desired product (refer to FIG. 1). The optical waveguide according to the second embodiment can be manufactured by, after the taking out of the above optical waveguide, covering the surface of the light guide portion 21 with another cladding film 10a (refer to FIG. 2).

According to the method of this embodiment, the cladding film 10 is brought into close contact with the surface of the mold 30, the surface having the recessed groove thereon, and the first and second through-holes 11 and 12 are then formed in the cladding film 10. Accordingly, the first and second through-holes 11 and 12 can be formed at positions corresponding to both ends of the recessed groove 34 with high accuracy, and the core 20 having a desired shape can be formed with high accuracy. Furthermore, unlike the case where a cladding film 10 in which first and second through-holes 11 and 12 are formed in advance is brought into close contact with a mold, alignment between both ends of the recessed groove 34 and the first and second through-holes 11 and 12 is not necessary, and thus a desired optical waveguide can be manufactured with high efficiency. In addition, when the pressing jig 40 is placed on the cladding film 10, and an appropriate pressure is applied to the mold 30 and the cladding film 10, misalignment between the mold 30 and the cladding film 10 can be reliably prevented in the subsequent steps, thus manufacturing non-defective products with high efficiency. Furthermore, the light-shielding film 43 can prevent the UV-curable resin filling the resin injection port 41 and the evacuation port 42, which are formed in the pressing jig 40, from being cured. Accordingly, it is not necessary to perform a post-treatment, e.g., removal of the cured UV-curable resin, and a large number of optical waveguides can be continuously manufactured using a single pressing jig 40. In addition, since the entire surface of the pressing jig 40 is irradiated with the resin-curing light L, curing of the core 20 can be conducted easily and with high efficiency.

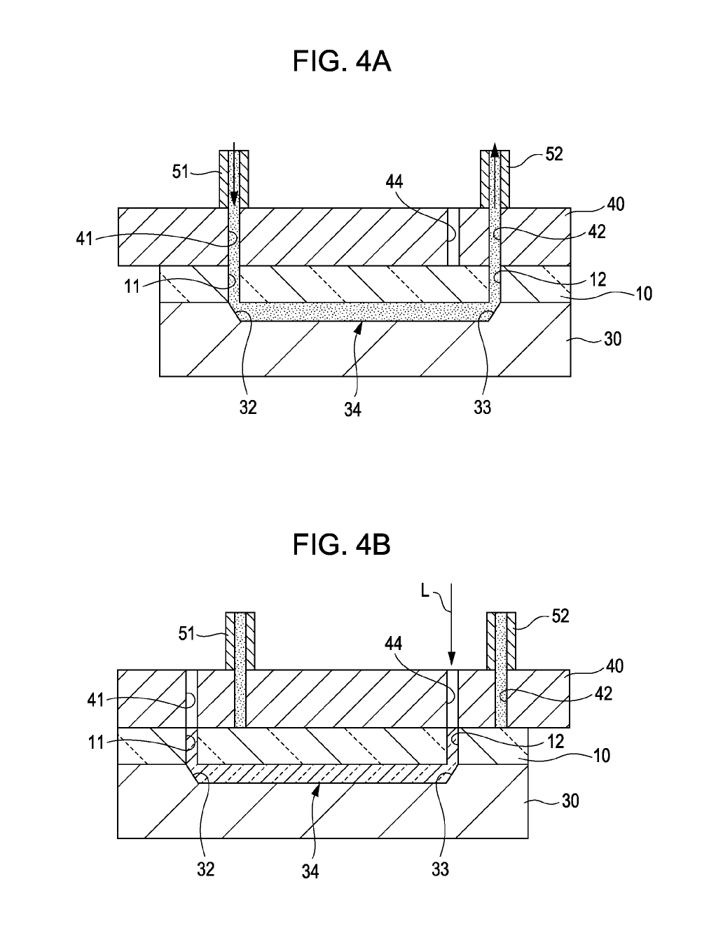

FIGS. 4A and 4B are views illustrating a second embodiment of a method for manufacturing the optical waveguides according to the first embodiment and the second embodiment. As is apparent from the drawings, in the method of this embodiment, an opaque pressing jig having a hole for exposure may be used, and a UV-curable resin filling a mold may be cured by resin-curing light that is propagated to the UV-curable resin through the hole for exposure.

A pressing jig 40 used in the method of this embodiment is composed of an opaque material, such as a metal plate, and has a resin injection port 41, an evacuation port 42, and a hole 44 for exposure that are formed at necessary positions thereof. A mold 30 and a cladding film 10 are manufactured as in the above-described method of the first embodiment.

Also in the method of this embodiment, steps are performed by the same procedure as that in the method of the first embodiment until a UV-curable resin for forming a core is injected in first and second through-holes 11 and 12 and a recessed groove 34. FIG. 4A shows a state in which the UV-curable resin for forming the core is injected in the first and second through-holes 11 and 12 and the recessed groove 34. As is apparent from FIG. 4A, in this state, the hole 44 for exposure and the through-holes 11 and 12 are arranged at positions shifted from each other in the plane direction.

Next, as shown in FIG. 4B, from this state, the pressing jig 40 is moved in the plane direction so that the position of the hole 44 for exposure coincides with the position of the first through-hole 11 or the second through-hole 12 (second through-hole 12 in the example shown in FIG. 4B). Subsequently, exposure means (not shown) such as an optical fiber, one end of which is connected to a light source, is inserted into the hole 44 for exposure, and resin-curing light L is applied to the second through-hole 12 through the hole 44 for exposure. The resin-curing light L applied on the second through-hole 12 propagates through the second through-hole 12, the recessed groove 34, and the first through-hole 11 in that order to cure the UV-curable resin filling these holes and groove. Thus, a desired core 20 is formed. Subsequently, as in the above-described method of the first embodiment, the pressing jig 40 is removed from the surface of the cladding film 10 and the mold 30 is then detached from the cladding film 10 at the interface therebetween, thus taking out an optical waveguide, which is the desired product (refer to FIG. 1). The optical waveguide according to the second embodiment can be manufactured by, after the taking out of the above optical waveguide, covering the surface of the light guide portion 21 with another cladding film 10a (refer to FIG. 2).

According to the method of this embodiment, the same advantages as those in the method of the first embodiment can be achieved. In addition, since the opaque pressing jig 40 is used in this embodiment, the light-shielding film 43 need not be formed, thus reducing the production cost of the pressing jig 40, and furthermore, the optical waveguides 1A and 1B.

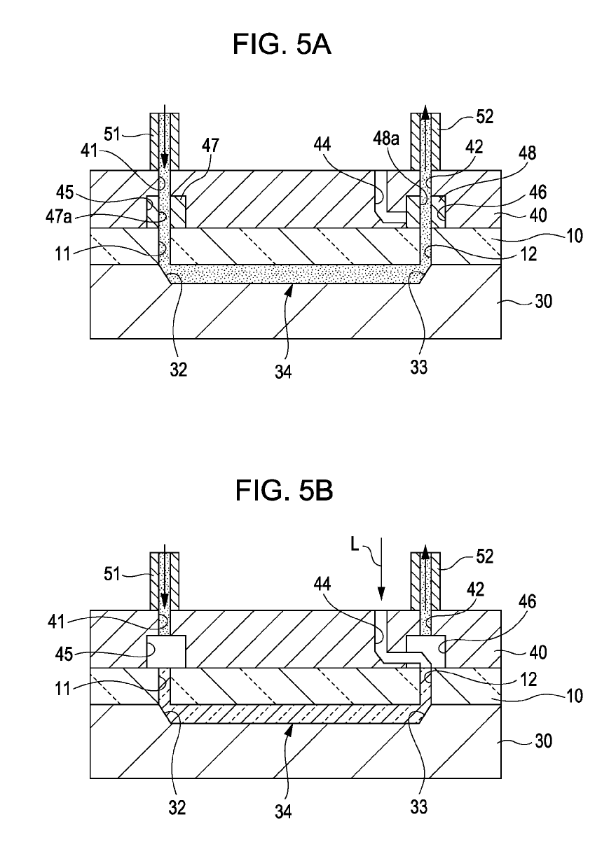

FIGS. 5A and 5B are views illustrating a third embodiment of a method for manufacturing an optical waveguide. As is apparent from the drawings, in the method of this embodiment, an opaque pressing jig including switching means for switching between a resin injection path and an exposure path, the switching means each including a slider insertion space and a slider inserted in the space, may be used.

A pressing jig 40 used in the method of this embodiment is composed of an opaque material, such as a metal plate. The pressing jig 40 has, at necessary positions, a first slider insertion space 45 communicating with a resin injection port 41 and a first through-hole 11, a second slider insertion space 46 communicating with an evacuation port 42 and a second through-hole 12, and a hole 44 for exposure communicating with either the first slider insertion space 45 or the second slider insertion space 46 (second slider insertion space 46 in the example shown in FIGS. 5A and 5B). A first slider 47 having a first resin-passing hole 47a communicating with the resin injection port 41 and the first through-hole 11 is slidably disposed in the first slider insertion space 45. A second slider 48 having a second resin-passing hole 48a communicating with the evacuation port 42 and the second through-hole 12 is slidably disposed in the second slider insertion space 46. A mold 30 and a cladding film 10 are manufactured as in the method of the first embodiment.

In the method of this embodiment, first, the first through-hole 11 and the second through-hole 12 are formed in the cladding film 10 that is brought into close contact with a surface of the mold 30, the surface having a recessed groove thereon. Subsequently, as shown in FIG. 5A, the pressing jig 40 is placed on the surface of the cladding film 10, and the pressing jig 40 is aligned with respect to the cladding film 10 so that the position of the first through-hole 11 coincides with the position of the resin injection port 41 and the position of the second through-hole 12 coincides with the position of the evacuation port 42, and the first slider 47 and the second slider 48 are aligned with respect to the pressing jig 40 so that the position of the first resin-passing hole 47a coincides with the positions of the resin injection port 41 and the first through-hole 11, and the position of the second resin-passing hole 48a coincides with the positions of the evacuation port 42 and the second through-hole 12. In this state, as in the method of the first embodiment, a UV-curable resin is injected from a resin supply device (not shown) to the first through-hole 11, a recessed groove 34, and the second through-hole 12 through the resin injection port 41.

Next, from this state, as shown in FIG. 5B, the first slider 47 and the second slider 48 are respectively moved to predetermined positions in the first slider insertion space 45 and the second slider insertion space 46, i.e., a position at which the first slider 47 is not interposed between the resin injection port 41 and the first through-hole 11 and a position at which the second slider 48 is not interposed between the evacuation port 42 and the second through-hole 12, so that the hole 44 for exposure provided in the pressing jig 40 communicates with the second slider insertion space 46. In this state, exposure means (not shown) such as an optical fiber, one end of which is connected to a light source, is inserted into the second slider insertion space 46 through the hole 44 for exposure, and resin-curing light L is applied to the second through-hole 12 through the hole 44 for exposure and the second slider insertion space 46. The resin-curing light L applied on the second through-hole 12 propagates through the second through-hole 12, the recessed groove 34, and the first through-hole 11 in that order to cure the UV-curable resin filling these holes and groove. Thus, a desired core 20 is formed. Subsequently, as in the above-described method of the first embodiment, the pressing jig 40 is removed from the surface of the cladding film 10 and the mold 30 is then detached from the cladding film 10 at the interface therebetween, thus taking out an optical waveguide, which is the desired product (refer to FIG. 1). The optical waveguide according to the second embodiment can be manufactured by, after the taking out of the above optical waveguide, covering the surface of the light guide portion 21 with another cladding film 10a (refer to FIG. 2).

According to the method of this embodiment, the set positions of the first slider 47 and the second slider 48 are appropriately switched in the first and second slider insertion spaces 45 and 46, respectively, using the pressing jig 40 in which the first and second slider insertion space 45 and 46 are formed and the first slider 47 and the second slider 48 are slidably disposed in the spaces 45 and 46, respectively, whereby both the supply of the UV-curable resin to the first and second through-holes 11 and 12 and the recessed groove 34, and the exposure of the UV-curable resin filling the first and second through-holes 11 and 12 and the recessed groove 34 through the hole 44 for exposure and the first slider insertion space 45 or the second slider insertion space 46 can be performed. Accordingly, alignment of the hole 44 formed in the pressing jig 40 and the first through-hole 11 or the second through-hole 12 formed in the cladding film 10 is not necessary, and thus the optical waveguide can be more efficiently manufactured.

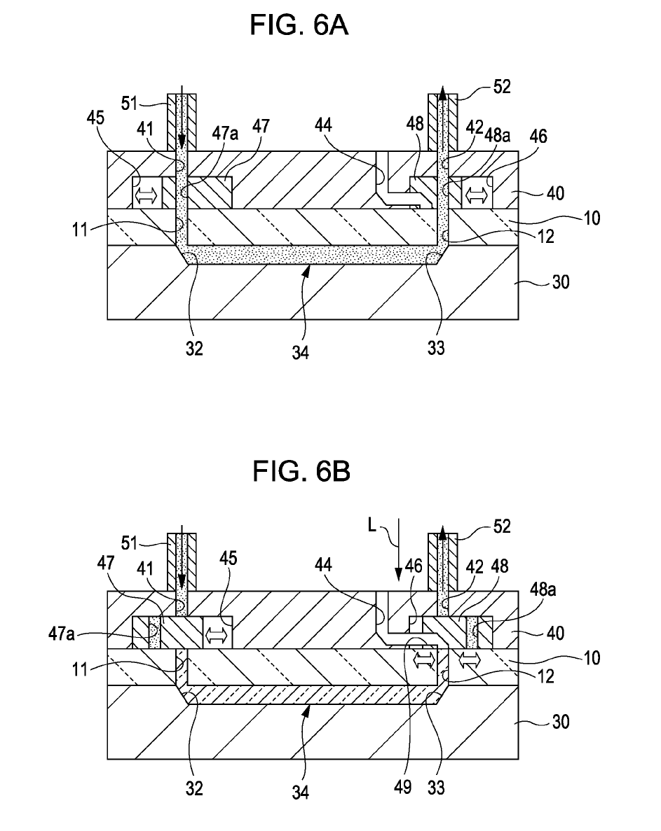

FIGS. 6A and 6B are views illustrating a fourth embodiment of a method for manufacturing an optical waveguide. As is apparent from the drawings, also in the method of this embodiment, an opaque pressing jig including switching means for switching between a resin injection path and an exposure path, the switching means each including a slider insertion space and a slider inserted in the space, may be used.

A pressing jig 40 used in the method of this embodiment is composed of an opaque material, such as a metal plate. The pressing jig 40 has, at necessary positions, a first slider insertion space 45 communicating with a resin injection port 41 and a first through-hole 11, a second slider insertion space 46 communicating with an evacuation port 42 and a second through-hole 12, and a hole 44 for exposure communicating with either the first slider insertion space 45 or the second slider insertion space 46 (second slider insertion space 46 in the example shown in FIGS. 6A and 6B). A first slider 47 having a first resin-passing hole 47a communicating with the resin injection port 41 and the first through-hole 11 is slidably disposed in the first slider insertion space 45. A second slider 48 having a second resin-passing hole 48a communicating with the evacuation port 42 and the second through-hole 12 and a second hole 49 for exposure communicating with the hole 44 for exposure is slidably disposed in the second slider insertion space 46. A mold 30 and a cladding film 10 are manufactured as in the method of the first embodiment.

In the method of this embodiment, first, the first through-hole 11 and the second through-hole 12 are formed in the cladding film 10 that is brought into close contact with a surface of the mold 30, the surface having a recessed groove thereon. Subsequently, the pressing jig 40 is placed on the surface of the cladding film 10, and the pressing jig 40 is aligned with respect to the cladding film 10 so that the position of the first through-hole 11 coincides with the position of the resin injection port 41 and the position of the second through-hole 12 coincides with the position of the evacuation port 42, and the first slider 47 and the second slider 48 are aligned with respect to the pressing jig 40 so that the position of the first resin-passing hole 47a coincides with the positions of the resin injection port 41 and the first through-hole 11, and the position of the second resin-passing hole 48a coincides with the positions of the evacuation port 42 and the second through-hole 12. As shown in FIG. 6A, the alignment of the sliders 47 and 48 can be automatically performed by bringing one side end of the first slider 47 and one side end of the second slider 48 into contact with one wall surface of the first slider insertion space 45 and one wall surface of the second slider insertion space 46, respectively. In this state, as in the method of the first embodiment, a UV-curable resin is injected from a resin supply device (not shown) to the first through-hole 11, a recessed groove 34, and the second through-hole 12 through the resin injection port 41

Next, from this state, as shown in FIG. 6B, the first slider 47 is moved to a position at which another side end of the first slider 47 is brought into contact with another wall surface of the first slider insertion space 45, and the second slider 48 is moved to a position at which another side end of the second slider 48 is brought into contact with another wall surface of the second slider insertion space 46. Consequently, the resin injection port 41 and the first through-hole 11 are blocked by the first slider 47, and the evacuation port 42 and the second through-hole 12 are blocked by the second slider 48. Also in this case, communication between the hole 44 for exposure and the second hole 49 for exposure provided in the second slider 48 is maintained through the second slider insertion space 46.

In this state, exposure means (not shown) such as an optical fiber, one end of which is connected to a light source, is inserted into the hole 44 for exposure, the second slider insertion space 46, and the second hole 49 for exposure. Resin-curing light L is applied to the second through-hole 12 through the hole 44 for exposure, the second slider insertion space 46, and the second hole 49 for exposure. The resin-curing light L applied on the second through-hole 12 propagates through the second through-hole 12, the recessed groove 34, and the first through-hole 11 in that order to cure the UV-curable resin filling these holes and groove. Thus, a desired core 20 is formed. Subsequently, as in the above-described method of the first embodiment, the pressing jig 40 is removed from the surface of the cladding film 10 and the mold 30 is then detached from the cladding film 10 at the interface therebetween, thus taking out an optical waveguide, which is the desired product (refer to FIG. 1). The optical waveguide according to the second embodiment can be manufactured by, after the taking out of the above optical waveguide, covering the surface of the light guide portion 21 with another cladding film 10a (refer to FIG. 2).

According to the method of this embodiment, the same advantages as those in the method of the third embodiment can be achieved. Furthermore, the alignment of the first and second sliders 47 and 48 in the steps of injecting the resin and curing the resin is performed by bringing one side end of the respective first and second sliders 47 and 48 into contact with one wall surface of the first and second slider insertion spaces 45 and 46, respectively, and thus the alignment operation of the sliders 47 and 48 in these steps can be facilitated to manufacture the optical waveguide efficiently.

More specific examples of the optical waveguides according to embodiments of the present invention will now be described.

### EXAMPLE 1

A nickel mold in which twelve groove portions each having a width of 50 μm, a depth of 50 μm, and a length of 50 mm were formed at a pitch of 250 μm and inclined surfaces inclined by 45° were formed at both ends of each of the groove portions was prepared by a transfer technique using electroforming. A transparent pressing jig in which resin injection ports and evacuation ports were formed at necessary positions and the wall surface of each of these ports was covered with a light-shielding film was also prepared using a glass plate. A fluorine-based mold releasing agent “Optool” manufactured by Daikin Industries Ltd. was applied onto a surface of the nickel mold, the surface having the groove portions thereon. “Arton Film” manufactured by JSR Corporation and having a thickness of 100 μm and a refractive index of about 1.51 was used as a cladding film, and oxygen plasma cleaning was performed on the surface of the film before use. The cladding film was brought into close contact with the surface of the nickel mold having the groove portions thereon, and first through-holes and second through-holes were then formed in the cladding film by laser machining at positions corresponding to the inclined surfaces. The pressing jig was placed on the cladding film. The first through-holes, the groove portions, and the second through-holes were filled with a UV-curable resin for forming a core, the resin having a refractive index after curing of about 1.55 and a viscosity of 600 mPa·s while applying an appropriate pressure to the mold and the cladding film. Subsequently, resin-curing light with an intensity of 2 J/cm2 was applied from the outside of the pressing jig to the filling UV-curable resin using a high-pressure mercury lamp.

### EXAMPLE 2

A nickel mold in which twelve groove portions each having a width of 50 μm, a depth of 50 μm, and a length of 50 mm were formed at a pitch of 250 μm and inclined surfaces inclined by 45° were formed at both ends of each of the groove portions was prepared by a transfer technique using electroforming. A pressing jig in which resin injection ports, evacuation ports, and holes for exposure were formed at necessary positions was also prepared using a metal plate. A fluorine-based mold releasing agent “Optool” manufactured by Daikin Industries Ltd. was applied onto a surface of the nickel mold, the surface having the groove portions thereon. “Arton Film” manufactured by JSR Corporation and having a thickness of 100 μm and a refractive index of about 1.51 was used as a cladding film, and oxygen plasma cleaning was performed on the surface of the film before use. The cladding film was brought into close contact with the surface of the nickel mold having the groove portions thereon, and first through-holes and second through-holes were then formed in the cladding film by laser machining at positions corresponding to the inclined surfaces. The pressing jig was placed on the cladding film. The first through-holes, the groove portions, and the second through-holes were filled with a UV-curable resin for forming a core, the resin having a refractive index after curing of about 1.55 and a viscosity of 600 mPa·s while applying an appropriate pressure to the mold and the cladding film. Subsequently, the pressing jig was moved so that the positions of the holes for exposure coincided with the positions of the corresponding second through-holes provided in the cladding film. A leading end of an optical fiber was inserted into each hole for exposure, and light from a UV light-emitting diode having a wavelength of 375 nm was applied to the filling UV-curable resin.

Note that in the above-described methods of the third embodiment and the fourth embodiment, switching means including a slider insertion space and a slider inserted in the space is used as the switching means for switching between a resin injection path and an exposure path. However, the gist of the present invention is not limited thereto, and other switching means may also be used. An example thereof is switching means including a rotation piece having a resin injection path and an exposure path and a space portion that accommodates the rotation piece in a rotatable manner.

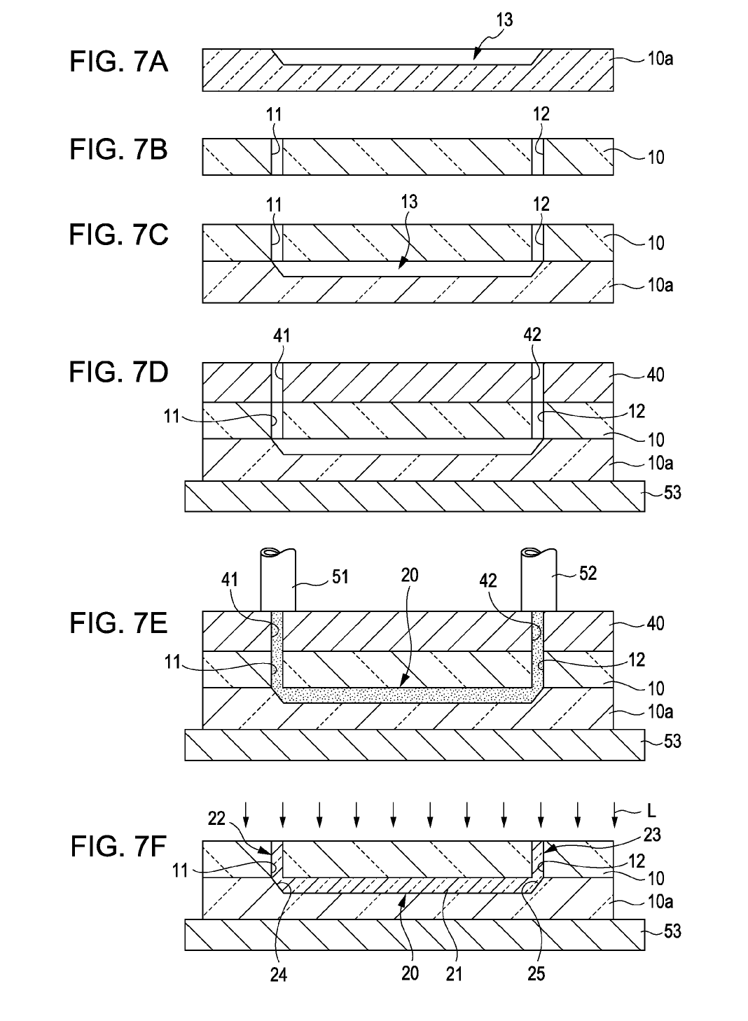

FIGS. 7A to 7F are views illustrating a fifth embodiment of a method for manufacturing an optical waveguide according to the present invention. As is apparent from the drawings, the method of this embodiment relates to a method for manufacturing the optical waveguide according to the second embodiment.

First, as shown in FIG. 7A, a second cladding film 10a in which a recessed groove 13 corresponding to a light guide portion 21 of a core 20 is formed on one surface thereof is prepared. In addition, as shown in FIG. 7B, a first cladding film 10 in which a first through-hole 11 and a second through-hole 12 are formed at positions corresponding to both ends of the recessed groove 13 is prepared.

The second cladding film 10a having the recessed groove 13 on the one surface thereof can be manufactured by applying so-called a thermal imprinting process. Specifically, first, a mold having a protrusion that has the same dimensions as those of the recessed groove 13 and a shape reverse with respect to the recessed groove 13 is prepared. A film base to be formed into the second cladding film 10a is pressed on one surface of the mold, the surface having the protrusion thereon, under heating to transfer a reverse pattern of the protrusion to the resin sheet. In this case, a mold releasing agent may be applied to the surface of the mold in order to improve the releasability of the second cladding film 10a from the mold. The mold is formed of, for example, nickel or a nickel alloy because such a metal exhibits good releasability of resins and thus a desired light guide portion 21 can be formed with high accuracy. The mold can be prepared as follows. The protrusion may be directly formed by cutting a nickel plate or a nickel alloy plate, which is used as a blank, by laser machining or the like. Alternatively, a master may be prepared by forming a recess composed of a photoresist and corresponding to the light guide portion 21 on a glass substrate by a photolithographic technique. Subsequently, the recess formed in the master may be transferred to a nickel mold or a nickel alloy mold by a transfer technique using electroforming.

The first and second through-holes 11 and 12 can be formed in the first cladding film 10 by laser machining or the like.

Next, as shown in FIG. 7C, the first cladding film 10 and the second cladding film 10a are positioned so that the recessed groove 13 is disposed inside and both ends of the recessed groove 13 face the first and second through-holes 11 and 12, and are then bonded to each other. The bonding between the first cladding film 10 and the second cladding film 10a is performed by bonding or thermocompression bonding.

Next, as shown in FIG. 7D, the bonded structure of the first cladding film 10 and the second cladding film 10a is placed on a film holder 53 so that the lower surface of the second cladding film 10a is held by the film holder 53. Furthermore, a pressing jig 40 is brought into contact with the surface of the first cladding film 10. Thus, the bonded structure of the first cladding film 10 and the second cladding film 10a is pressed under an appropriate pressure with the film holder 53 and the pressing jig 40. A resin injection port 41 corresponding to the first through-hole 11 and an evacuation port 42 corresponding to the second through-hole 12 are formed in the pressing jig 40. In the step of pressing, the first cladding film 10 and the pressing jig 40 are arranged so that the position of the first through-hole 11 coincides with the position of the resin injection port 41 and the position of the second through-hole 12 coincides with the position of the evacuation port 42.

Lastly, as shown in FIG. 7E, a head 51 of a resin supply device and a head 52 of a suction device are respectively connected to the resin injection port 41 and the evacuation port 42 of the pressing jig 40. The pressure in the recessed groove 13 is reduced by suctioning the air in the through-holes 11 and 12 and the recessed groove 13 using the suction device. When the pressure in the recessed groove 13 is reduced to a predetermined value or less, a UV-curable resin for forming a core is injected from the resin supply device to the first through-hole 11, the recessed groove 13, and the second through-hole 12. Thus, the through-holes 11 and 12 and the recessed groove 13 can be filled with the UV-curable resin with high efficiency, mixing of air bubbles in the core 20 can be prevented, and non-defective products can be manufactured with high efficiency. When the through-holes 11 and 12 and the recessed groove 13 are filled with the UV-curable resin, the supply of the resin from the resin supply device is stopped, and the heads 51 and 52 are detached from the pressing jig 40. The pressing jig 40 is then detached from the surface of the bonded structure of the first cladding film 10 and the second cladding film 10a. In this state, as shown in FIG. 7F, light L for curing the UV-curable resin (also referred to as “resin-curing light L”) is applied from the outer surface of the first cladding film 10. Accordingly, the optical waveguide 1B shown in FIG. 2 is formed.

In this embodiment, the air in the recessed groove 13 is discharged through the second through-hole 12, and the filling of the polymeric material is performed through the first through-hole 11. Alternatively, the air in the recessed groove 13 may be discharged through the first through-hole 11, and the filling of the polymeric material may be performed through the second through-hole 12.

In the method of this embodiment, the recessed groove 13 and the first and second through-holes 11 and 12 are filled with a polymeric material for forming a core through the first through-hole 11 or the second through-hole 12 that is formed in the first cladding film 10. Accordingly, the bonding of the first cladding film 10 to the second cladding film 10a and the filling of the bonded cladding films 10 and 10a with the polymeric material can be continuously performed, and it is possible to highly efficiently manufacture the optical waveguide 1B in which the core 20 is completely protected by being covered with the first and second cladding films 10 and 10a. Furthermore, according to the method of this embodiment, the recessed groove 13 corresponding to the light guide portion 21 of the core 20 is formed by applying a so-called fine print technique. Accordingly, the second cladding film having a fine recessed groove 13 can be efficiently manufactured with high accuracy, and a high-performance optical waveguide can be manufactured at a low cost. Furthermore, according to the method of this embodiment, in the step of filling the through-holes 11 and 12 and the recessed groove 13 with a polymeric material, the filling of the polymeric material under pressure is performed while evacuating the space formed by the through-holes 11 and 12 and the recessed groove 13. Accordingly, the filling of the through-holes 11 and 12 and the recessed groove 13 with the polymeric material can be performed with high efficiency, mixing of air bubbles in the polymeric material can be prevented, and non-defective products can be manufactured with high efficiency. In addition, in the method of this embodiment, since the bonded structure of the first cladding film 10 and the second cladding film 10a is held with the film holder 53 and the pressing jig 40, filling of the through-holes 11 and 12 and the recessed groove 13 with the polymeric material can be stably performed to increase the yield of non-defective products. Furthermore, in the method of this embodiment, since the polymeric material filling the resin injection port 41 and the evacuation port 42 is left uncured, a phenomenon in which the polymeric material for forming the core is cured and the cured polymeric material adheres to the pressing jig 40 does not occur. Accordingly, it is not necessary to perform a post-treatment, e.g., removal of such cured polymeric material portions. Consequently, filling of a polymeric material can be continuously repeated using the same pressing jig 40 to manufacture the optical waveguide 1B with high efficiency.

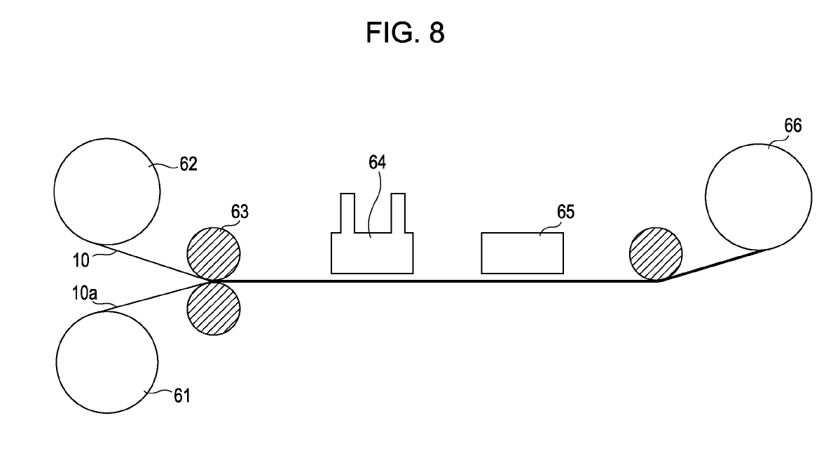

FIG. 8 is a view illustrating a more practical embodiment of the method of the fifth embodiment. As is apparent from FIG. 8, in the method of this embodiment, the second cladding film 10a having the recessed groove 13 thereon and the first cladding film 10 in which the first and second through-holes 11 and 12 are formed are each prepared in the form of a long ribbon. The second cladding film 10a is wound around a first reel 61 and the first cladding film 10 is wound around a second reel 62. The second cladding film 10a and the first cladding film 10 drawn from the first reel 61 and the second reel 62, respectively, are supplied to a line including film bonding means 63 such as bonding rollers, a resin-filling device 64 including a suction device and a resin supply device, a resin-curing lamp 65 such as a high-pressure mercury lamp, and a winding roller 66 to manufacture a continuous product of the optical waveguides 1B. The continuous product of the optical waveguides 1B wound around the winding roller 66 is then transferred to a cutting process (not shown), and cut and molded to form desired optical waveguides 1B.

According to the method of this embodiment, manufacturing of the first cladding film 10 and the second cladding film 10a, bonding of these cladding films 10 and 10a, filling of the resulting bonded first and second cladding films 10 and 10a with a polymeric material, and curing of the polymeric material can be continuously performed, and thus an optical waveguide can be manufactured more efficiently.

A specific example of the optical waveguide according to an embodiment of the present invention will now be described.

### EXAMPLE 3

A nickel mold in which twelve protrusions each having a width of 50 μm, a depth of 50 μm, and a length of 50 mm were formed in parallel at a pitch of 250 μm and inclined surfaces inclined by 45° were formed at both ends of each of the protrusions was prepared by a transfer technique using electroforming As a film base to be formed into the first cladding film 10 and the second cladding film 10a, a norbornene heat-resistant transparent resin “Arton Film” manufactured by JSR Corporation and having a thickness of 100 μm and a refractive index of about 1.51 was prepared. In manufacturing the second cladding film 10a, a fluorine-based mold releasing agent “Optool” manufactured by Daikin Industries Ltd. was applied onto a surface of the nickel mold, the surface having the protrusions thereon, and oxygen plasma cleaning was performed on the surface of the film base. The second cladding film 10a was manufactured by pressing the film base on the surface of the heated nickel mold having the protrusions thereon. On the other hand, the first cladding film 10 was manufactured by forming first through-holes 11 and second through-holes 12 in the film base by laser machining Next, the first cladding film 10 and the second cladding film 10a were bonded to each other with an adhesive therebetween. The first through-holes 11, the groove portions 13, and the second through-holes 12 were filled with a UV-curable resin for forming a core, the resin having a refractive index after curing of about 1.55 and a viscosity of 600 mPa·s while applying an appropriate pressure between a film holder 53 and a pressing jig 40. Subsequently, resin-curing light with an intensity of 2 J/cm2 was applied from the outside of the pressing jig 40 to the filling UV-curable resin using a high-pressure mercury lamp.

### Third Embodiment and Fourth Embodiment of Optical Waveguide

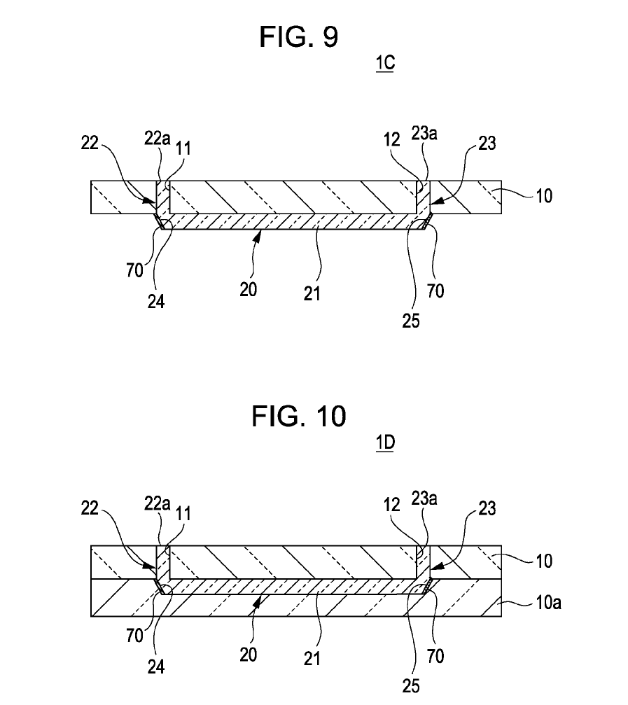

Optical waveguides according to a third embodiment and a fourth embodiment of the present invention will now be described with reference to FIGS. 9 and 10. FIG. 9 is a cross-sectional view of the optical waveguide according to the third embodiment, and FIG. 10 is a cross-sectional view of the optical waveguide according to the fourth embodiment.

As shown in FIG. 9, an optical waveguide 1C of the third embodiment includes a reflective film 70 provided on each of the mirror surfaces 24 and 25 of the optical waveguide according to the first embodiment. As shown in FIG. 10, an optical waveguide 1D of the fourth embodiment includes a reflective film 70 provided on each of the mirror surfaces 24 and 25 of the optical waveguide according to the second embodiment.

The reflective film 70 is formed by depositing a metal having a high reflectivity, e.g., aluminum or silver, or an alloy containing such a metal as a main component on each of the mirror surfaces 24 and 25 by vacuum evaporation. Alternatively, in the case where the optical waveguide is manufactured using the mold 30 (refer to FIGS. 3A to 6B), the reflective film 70 may be deposited on portions of the mold 30, the portion corresponding to the mirror surfaces 24 and 25, by vacuum evaporation, and the reflective film 70 may then be transferred to the mirror surfaces 24 and 25 of the core 20 in the step of detaching the mold 30 from the core 20. Note that it is sufficient that the reflective film 70 is formed only on the mirror surfaces 24 and 25. However, in order to reduce the production cost of the optical waveguide, the portions where the reflective film 70 is formed are not necessarily limited to the mirror surfaces 24 and 25 only, and forming the reflective film 70 on the bottom surface of the light guide portion 21 is also allowable. The reason for this is as follows. In order to form the reflective film 70 only on the mirror surfaces 24 and 25, it is necessary to prepare a mask for limiting the portions where the reflective film 70 is formed to the mirror surfaces 24 and 25 only, or it is necessary to perform a post-treatment for removing the reflective film 70 deposited on an unnecessary portion. Accordingly, forming the reflective film 70 on the bottom surface of the light guide portion 21 is allowable in order that the cost of the optical waveguide is reduced by omitting the above requirements.

The formation of the reflective film 70 on the mirror surfaces 24 and 25 of the core 20 can increase the light reflection efficiency in the mirror surfaces 24 and 25. Accordingly, even when a sufficient difference in the refractive index between the core 20 and the cladding films 10 and 10a cannot be ensured, an optical waveguide having high light propagation efficiency can be provided.

### Fifth Embodiment of Optical Waveguide

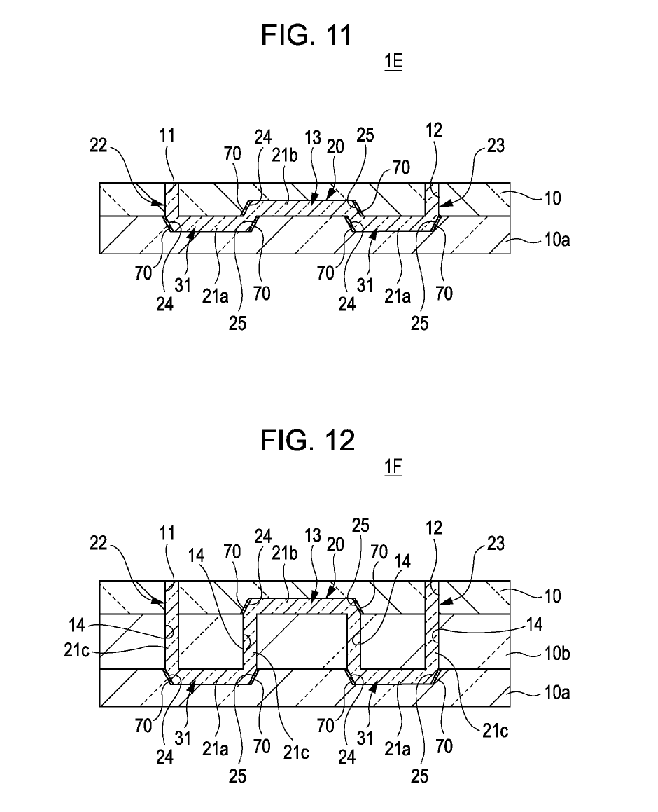

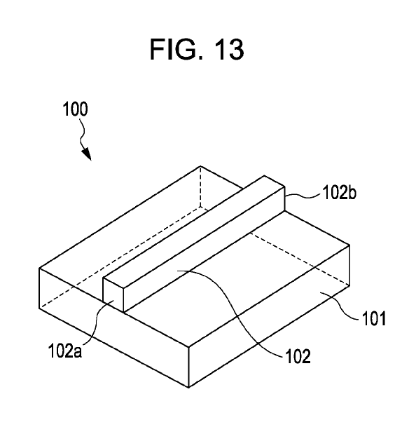

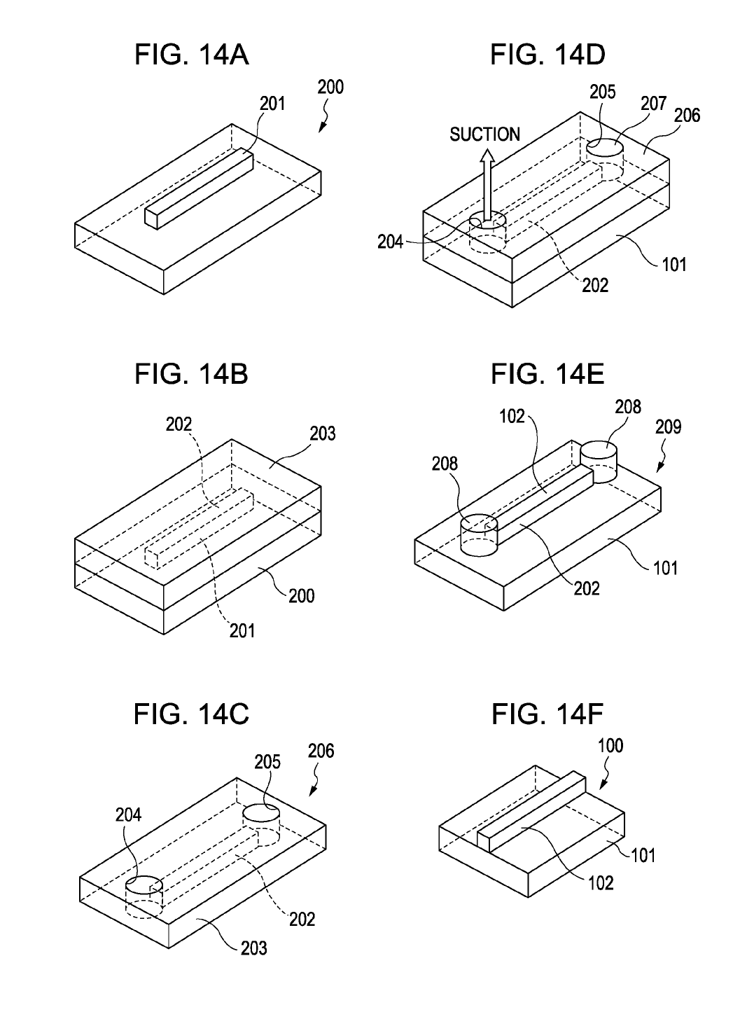

An optical waveguide according to a fifth embodiment of the present invention will now be described with reference to FIG. 11. FIG. 11 is a cross-sectional view of the optical waveguide according to the fifth embodiment.

As shown in FIG. 11, an optical waveguide 1E according to the fifth embodiment includes two cladding films, namely, a first cladding film 10 and a second cladding film 10a. A plurality of (two in the example shown in FIG. 11) first light guide portions 21a are provided in the second cladding film 10a. A second light guide portion 21b that directly connects ends of these first light guide portions 21a to each other is provided in the first cladding film 10. Furthermore, a reflective film 70 is provided on each mirror surface formed on the first light guide portions 21a and the second light guide portion 21b. Other structures are the same as those of the optical waveguide according to the fourth embodiment, and thus corresponding portions are assigned the same reference numerals and a description thereof is omitted.

According to the optical waveguide 1E of this embodiment, a light guide portion is constituted by a connected body including the plurality of first light guide portions 21a provided in the second cladding film 10a and the second light guide portion 21b provided in the first cladding film 10. Accordingly, a light guide portion having any length can be formed, thus expanding the application range of this type of optical waveguide.

The optical waveguide 1E according to the fifth embodiment can be manufactured as follows. First, recessed grooves 31 corresponding to the plurality of first light guide portions 21a are formed on one surface of the second cladding film 10a. A first through-hole 11 and a second through-hole 12 are formed in the first cladding film 10. Furthermore, a connecting recessed groove 13 corresponding to the second light guide portion 21b and connecting one end of one recessed groove 31 provided in the second cladding film 10a to one end of another recessed groove 31 provided in the second cladding film 10a is formed on one surface of the first cladding film 10. Next, the first cladding film 10 and the second cladding film 10a are positioned so that the position of the end of each of the recessed grooves 31 coincides with the position of the corresponding end of the connecting recessed groove 13, the position of the first through-hole 11 coincides with the position of another end of the one recessed groove 31, and the position of the second through-hole 12 coincides with the position of another end of the other recessed groove 31. Subsequently, the second through-hole 12, the recessed grooves 31, the connecting recessed groove 13, and the first through-hole 11 are filled with a polymeric material for forming a core under pressure through the second through-hole 12 while suctioning the air in the first through-hole 11, the recessed grooves 31, the connecting recessed groove 13, and the second through-hole 12 through the first through-hole 11.

### Sixth Embodiment of Optical Waveguide

An optical waveguide according to a six embodiment of the present invention will now be described with reference to FIG. 12. FIG. 12 is a cross-sectional view of the optical waveguide according to the sixth embodiment.

As shown in FIG. 12, an optical waveguide 1F according to the sixth embodiment includes three cladding films, namely, a first cladding film 10, a second cladding film 10a, and a third cladding film 10b. A plurality of (two in the example shown in FIG. 12) first light guide portions 21a are provided in the second cladding film 10a. A second light guide portion 21b is provided in the first cladding film 10. Connecting light guide portions 21c each connecting an end of a first light guide portion 21a to the corresponding end of the second light guide portion 21b are provided in the third cladding film 10b. A reflective film 70 is provided on each mirror surface formed on the first light guide portions 21a and the second light guide portion 21b. Other structures are the same as those of the optical waveguide according to the fourth embodiment, and thus corresponding portions are assigned the same reference numerals and a description thereof is omitted. The optical waveguide 1F of this embodiment also achieves substantially the same advantage as that of the optical waveguide 1E of the fifth embodiment.

The optical waveguide 1F according to the sixth embodiment can be manufactured as follows. First, recessed grooves 31 corresponding to the plurality of first light guide portions 21a are formed on one surface of the second cladding film 10a. A first through-hole 11 and a second through-hole 12 are formed in the first cladding film 10. Furthermore, a connecting recessed groove 13 corresponding to the second light guide portion 21b is formed on one surface of the first cladding film 10. Through-holes 14 corresponding to the connecting light guide portions 21c are formed in the third cladding film 10b. The second cladding film 10a, the third cladding film 10b, and the first cladding film 10 are stacked in that order so that the position of each end of the recessed grooves 31 coincides with the position of an end of corresponding through-hole 14 and the position of another end of each through-hole 14 coincides with the position of the corresponding first through-hole 11 or the second through-hole 12. Subsequently, the second through-hole 12, the through-holes 14, the recessed grooves 31, the connecting recessed groove 13, and the first through-hole 11 are filled with a polymeric material for forming a core under pressure through the second through-hole 12 while suctioning the air in the first through-hole 11, the through-holes 14, the recessed grooves 31, the connecting recessed groove 13, and the second through-hole 12 through the first through-hole 11.

What is claimed is:

1. A method for manufacturing an optical waveguide comprising the steps of:
bringing a grooved member having, on one surface thereof, a recessed groove for forming a light guide portion into close contact with a cladding film having a first through-hole and a second through-hole at positions corresponding to both ends of the recessed groove; and then
filling, under pressure, the second through-hole, the recessed groove, and the first through-hole with a polymeric material for forming a core through the second through-hole while suctioning the air in the first through-hole, the recessed groove, and the second through-hole through the first through-hole.

2. The method according to claim 1, wherein the grooved member is a mold separate from the optical waveguide.

3. The method according to claim 1, wherein the grooved member is another cladding film constituting a cladding of the optical waveguide together with the cladding film.

4. The method according to claim 1, further comprising a step of:
forming the recessed groove on the one surface of the grooved member so that mirror surfaces constituted by inclined surfaces are integrally formed at both ends of the recessed groove.

5. The method according to claim 4, further comprising a step of:
forming a reflective film on at least the mirror surfaces out of the bottom surface of the recessed groove and the mirror surfaces, the step being performed after the formation of the recessed groove and the mirror surfaces on the grooved member.

6. The method according to claim 5,
wherein, in the case where the grooved member is a mold, after the polymeric material for forming the core, the polymeric material filling the first through-hole, the recessed groove, and the second through-hole under pressure is cured, the reflective film is transferred to at least the mirror surfaces out of the bottom surface of the core and the mirror surfaces when the grooved member functioning as the mold is detached from the core.

7. The method according to claim 1,
wherein a plurality of the recessed grooves are formed on the one surface of the grooved member,
the first through-hole and the second through-hole are formed in the cladding film,
a connecting recessed groove connecting an end of one recessed groove to an end of another recessed groove, the recessed grooves being formed on the surface of the grooved member, is formed on one surface of the cladding film,
the positions of the ends of the recessed grooves are adjusted to coincide with the positions of ends of the connecting recessed groove,
the position of the first through-hole and the position of the second through-hole are respectively adjusted to coincide with another end of the one recessed groove and another end of the other recessed groove, and
the second through-hole, the other recessed groove, the connecting recessed groove, the one recessed groove, and the first through-hole are then filled under pressure with the polymeric material for forming the core through the second through-hole while suctioning the air in the first through-hole, the one recessed groove, the connecting recessed groove, the other recessed groove, and the second through-hole through the first through-hole.

8. The method according to claim 2, further comprising the steps of:
preparing a mold having a recessed groove for forming a light guide portion, a cladding film, and a pressing jig having a resin injection port and an evacuation port at positions corresponding to both ends of the recessed groove;
bringing the cladding film into close contact with the surface of the mold, the surface having the recessed groove thereon;
forming the first through-hole and the second through-hole for respectively forming a light input portion and a light output portion in the cladding film at positions corresponding to both ends of the recessed groove;
placing the pressing jig on the cladding film so that the positions of the first and second through-holes formed in the cladding film respectively coincide with the positions of the resin injection port and the evacuation port formed in the pressing jig;
fixing the mold and the cladding film using the pressing jig, and then filling, under pressure, the resin injection port, the first through-hole, the recessed groove, the second through-hole, and the evacuation port with a polymeric material for forming a core through the resin injection port while suctioning the air in the evacuation port, the second through-hole, the recessed groove, the first through-hole, and the resin injection port through the evacuation port;
selectively curing only the polymeric material filling the recessed groove and the polymeric material filling the first and second through-holes to form the core so that the polymeric material filling the resin injection port and the polymeric material filling the evacuation port are left uncured; and
detaching the pressing jig from the surface of the cladding film, and detaching the cladding film having the core integrally formed therewith from the mold.

9. The method according to claim 8,
wherein the pressing jig is composed of a transparent material, and a light-shielding film is selectively provided on necessary portions including at least a wall surface of the resin injection port and a wall surface of the evacuation port,
the polymeric material for forming the core is a UV-curable resin, and
after the resin injection port, the first through-hole, the recessed groove, the second through-hole, and the evacuation port are filled with the UV-curable resin for forming the core through the resin injection port, resin-curing light is applied to the entire surface of the pressing jig.

10. The method according to claim 8,
wherein the pressing jig is composed of an opaque material and has a hole for exposure, the hole being disposed at a position different from the positions of the resin injection port and the evacuation port,
the polymeric material for forming the core is a UV-curable resin, and
after the resin injection port, the first through-hole, the recessed groove, the second through-hole, and the evacuation port are filled with the UV-curable resin for forming the core through the resin injection port, the pressing jig is moved so that the position of the hole for exposure coincides with the position of the first through-hole or the second through-hole formed in the cladding film, and resin-curing light is applied to the UV-curable resin filling the first and second through-holes and the UV-curable resin filling the recessed groove through the hole for exposure.

11. The method according to claim 8,
wherein the pressing jig is composed of an opaque material, is provided with switching means for switching between a resin injection path and an exposure path, the switching means being disposed at a position communicating with the resin injection port and the first through-hole and a position communicating with the evacuation port and the second through-hole, and has a hole for exposure communicating with one of the switching means,
the polymeric material for forming the core is a UV-curable resin,
the switching means are switched to a state in which the resin injection port communicates with the first through-hole and the evacuation port communicates with the second through-hole, and the resin injection port, the first through-hole, the recessed groove, the second through-hole, and the evacuation port are filled with the UV-curable resin for forming the core through the resin injection port, and
the switching means are then switched to a state in which the hole for exposure communicates with the first through-hole or the second through-hole, and resin-curing light is applied to the UV-curable resin filling the first and second through-holes and the UV-curable resin filling the recessed groove through the hole for exposure.

12. The method according to claim 11, wherein the switching means for switching between the resin injection path and the exposure path each comprise a slider insertion space formed in the pressing jig and a slider configured to be inserted into the slider insertion space.

13. The method according to claim 3, further comprising the steps of:
preparing a first cladding film having a recessed groove for forming a light guide portion having inclined mirror surfaces at both ends thereof and a second cladding film having a first through-hole and a second through-hole for respectively forming a light input portion and a light output portion at positions corresponding to both ends of the recessed groove;
bonding the second cladding film to a surface of the first cladding film, the surface having the recessed groove thereon, so that the first through-hole and the second through-hole face the ends of the recessed groove;
filling the recessed groove and one of the first through-hole and the second through-hole with a polymeric material for forming a core through the other through-hole; and
curing the filling polymeric material to form the core including the light input portion, the light guide portion, the light output portion, a first mirror surface configured to guide light incident on the light input portion to the light guide portion, and a second mirror surface configured to guide the light that has propagated through the light input portion to the light output portion, the core being formed integrally with the first and second cladding films.

14. The method according to claim 13,
wherein the step of preparing the first cladding film and the second cladding film includes preparing a ribbon-shaped first cladding film including a large number of the recessed grooves formed in the longitudinal direction at certain intervals and winding the first cladding film around a first reel, and preparing a ribbon-shaped second cladding film including a large number of the first and second through-holes formed in the longitudinal direction at certain intervals and winding the second cladding film around a second reel, and
the step of bonding the second cladding film to the surface of the first cladding film, the surface having the recessed groove thereon, includes bonding the first cladding film drawn from the first reel to the second cladding film drawn from the second reel.

15. The method according to claim 13, wherein the step of preparing the first cladding film includes preparing a mold having a protrusion corresponding to the recessed groove and a film base to be formed into the first cladding film, and pressing the film base onto a surface of the mold, the surface having the protrusion thereon, under heating to transfer the recessed groove corresponding to the protrusion to one surface of the film base.

16. The method according to claim 13, wherein the step of filling the first through-hole, the recessed groove, and the second through-hole with the polymeric material for forming the core includes holding the lower surface of the first cladding film with a film holder, pressing the top surface of the second cladding film with a pressing jig having a resin injection port corresponding to the first through-hole and an evacuation port corresponding to the second through-hole, and filling, under pressure, the second through-hole, the recessed groove, and the first through-hole with the polymeric material for forming the core through the resin injection port while suctioning the air in the first through-hole, the recessed groove, and the second through-hole through the evacuation port.

17. The method according to claim 16, wherein the step of curing the filling polymeric material includes selectively curing only the polymeric material filling the second through-hole, the recessed groove, and the first through-hole to leave the polymeric material filling the resin injection port and the evacuation port uncured.

18. An optical waveguide comprising:
a cladding film; and
a core composed of a polymeric material and formed integrally with the cladding film,
wherein the core includes a light guide portion formed on one surface of the cladding film, a light input portion, and a light output portion, the light input portion and the light output portion being connected to both ends of the light guide portion and being formed in through-holes provided in the cladding film in the same step as the formation of the light guide portion.

19. The optical waveguide according to claim 18, further comprising:
a mirror surface configured to guide light incident on the light input portion to the light guide portion; and
a mirror surface configured to guide the light that has propagated through the light guide portion to the light output portion, the mirror surfaces being disposed at both ends of the light guide portion.

20. The optical waveguide according to claim 18, wherein the light guide portion, the light input portion, and the light output portion have substantially the same cross-sectional shape and cross-sectional area.

21. The optical waveguide according to claim 18, wherein the core is composed of a UV-curable resin.

22. The optical waveguide according to claim 18, wherein the light guide portion of the core is covered with two cladding films.

23. The optical waveguide according to claim 19, wherein a reflective film is provided on each of the mirror surfaces.

24. The optical waveguide according to claim 22, wherein the light guide portion includes a plurality of first light guide portions provided on one of the two cladding films and a second light guide portion provided on the other cladding film and optically connected to ends of the first light guide portions either directly or through connecting light guide portions.
